(19) United States
(12) Patent Application Publication
(10) Pub. No.: US 2004/0102938 A1
(43) Pub. Date: May 27, 2004

(54) Method and device for creating analytical mesh data

(75) Inventors: Yasushi Nakashima, Tokyo (JP); Shin Kawabe, Tokyo (JP)

Correspondence Address: BURNS, DOANE, SWECKER & MATHIS, L.L.P., P.O. Box 1404, Alexandria, VA, 22313-1404, US

(73) Assignee: MITSUBISHI DENKI KABUSHIKI KAISHA

(21) Appl. No.: 10/411,226

(22) Filed: Apr. 11, 2003

(30) Foreign Application Priority Data
Nov. 21, 2002 (JP) 2002-337784

(51) Int. Cl. G06F 17/10

(52) U.S. Cl. 703/2

(57) ABSTRACT

Coordinates of vertices of each triangle in the polygon data are extracted, the extracted coordinates of vertices of each triangle of the polygon data are replaced with coordinates of vertices of triangles of the analytical mesh data, and predetermined header and footer are added to obtain analytical mesh data.

### BACKGROUND OF THE INVENTION

1) Field of the Invention

The present invention relates to a technology for creating analytical mesh data that is required for simulation of a three dimensional model.

2) Description of the Related Art

A product is analyzed in various ways from the design phase until the production phase. These analyses include, for example, structural analysis, strength analysis, thermal current analysis, electromagnetic field analysis, and are generally carried out (i.e., simulated) on a computer. These analyses are collectively termed as Computer Aided Engineering (CAE). Particularly, in three-dimensional computer-aided designing (hereinafter “three dimensional CAD”), there is a need to create analytical mesh data to simulate various analyses on the computer, using an analytical software program or an analytical mesh data creating software program. The analytical mesh data created in this way may be a triangular mesh data.

Conventionally, a simulation device that creates lattice data and performs calculations fast and gives highly accurate results was known. An example of a conventional simulation device is described in the Japanese Patent Laid-Open Publication No. 11-66356. The simulation device disclosed in this publication converts the spatial data of an object generated by the three dimensional CAD to a predetermined format and creates lattice data thereof using data of the three dimensional CAD.

Generally, the analytical software program or the analytical mesh data creating software program can easily create the analytical mesh data since these programs support the reading of the data format of the three dimensional CAD. The analytical software program and the mesh data creating analytical software program may also be combined into a single software and hence will be referred hereinafter as the “mesh data creating analytical software program”. The data format of the three dimensional CAD maybe initial graphics exchange specification (IGES), standard for the exchange of product model data (STEP) or the like.

In the design phase, when the simulation device analyses a mock model of the object and data of the three dimensional CAD thereof do not exist, the simulation device needs to create an analytical mesh data thereof. The analytical mesh data is created as follows. A three-dimensional-measuring device performs measurements to obtain x, y, z coordinates of many points (hereafter “measurement points”) on a surface of the object (hereinafter “measurement data”). Then, the simulation device creates the analytical mesh data of the object based on the measurement data. In this context, the conventional art has a disadvantage of consuming long time for creating the analytical mesh data.

Recently, a reverse engineering software program that can easily create polygon data from three dimensional data was introduced. First, this reverse engineering software program creates polygon data of the object based on the measurement data. The polygon data is, for example, an accumulation of triangles. Next, the reverse engineering software program creates data of the surface model (hereinafter “surface data”) of the object based on the polygon data. The surface data is, for example, an accumulation of vertices of a plurality of rectangles. Following this, the reverse engineering software program creates the analytical mesh data from the surface data by means of the mesh data creating analytical software program.

However, the conventional art has inherent defects that affect the efficiency thereof. Generally, the mesh data creating analytical software program accepts data in the form of the surface data only. In addition, these programs require to go through a first step of creating the polygon data from the three dimensional data and then a second step of creating the surface data from the polygon data.

Moreover, the creation of the surface data is largely manual although the creation of the polygon data is largely automated. In addition, the time required for creating the surface data is several times that of the polygon data.

### SUMMARY OF THE INVENTION

It is an object of the present invention to solve at least the problems in the conventional technology.

The method of creating analytical mesh data based on polygon data that is created based on measurement data of an object to be analyzed, according to one aspect of the present invention comprises extracting coordinates of each vertex of each triangle in the polygon data; replacing the extracted coordinates with corresponding coordinates of each vertex of each triangle of the analytical mesh data; replacing a header of the polygon data with a header of the analytical mesh data; and replacing a footer of the polygon data with a footer of the analytical mesh data.

The method of creating analytical mesh data based on polygon data that is created based on measurement data of an object to be analyzed, according to another aspect of the present invention comprises extracting coordinates of each vertex of each triangle in the polygon data; replacing the extracted coordinates with corresponding coordinates of each vertex of each triangle of the analytical mesh data; and adding a predetermined header and footer to the analytical mesh data.

The device for creating analytical mesh data based on polygon data that is created based on measurement data of an object to be analyzed, according to still another aspect of the present invention comprises a data extractor that extracts coordinates of each vertex of each triangle in the polygon data; a data replacer that replaces the extracted coordinates with corresponding coordinates of each vertex of each triangle of the analytical mesh data; and a file creator that adds a predetermined header and footer.

The computer program according to still another aspect of the present invention realizes the methods according to the present invention on a computer.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 illustrates the process of creating analytical mesh data in the conventional art;

FIG. 2 illustrates the process of creating analytical mesh data according to an embodiment of the present invention;

FIG. 3A shows the format of a polygon data file;

FIG. 3B shows the format of an analytical mesh data file;

FIG. 4 shows the process of creating the analytical mesh data file from the polygon data file;

FIG. 5 is a block diagram that shows the functional configuration of an analytical mesh data creating device according to the embodiment;

FIG. 6 shows the detailed format of an input data exchange format file and an output file;

FIG. 7 is a flowchart that shows how a universal file is created from a DXF file;

FIG. 8A explains a step S109 shown in FIG. 7 in detail; and

FIG. 8B explains a step S110 shown in FIG. 7 in detail.

### DETAILED DESCRIPTION

An exemplary embodiment of the analytical mesh data creating method and the analytical mesh data creating device according to the present invention are explained below with reference to the accompanying drawings.

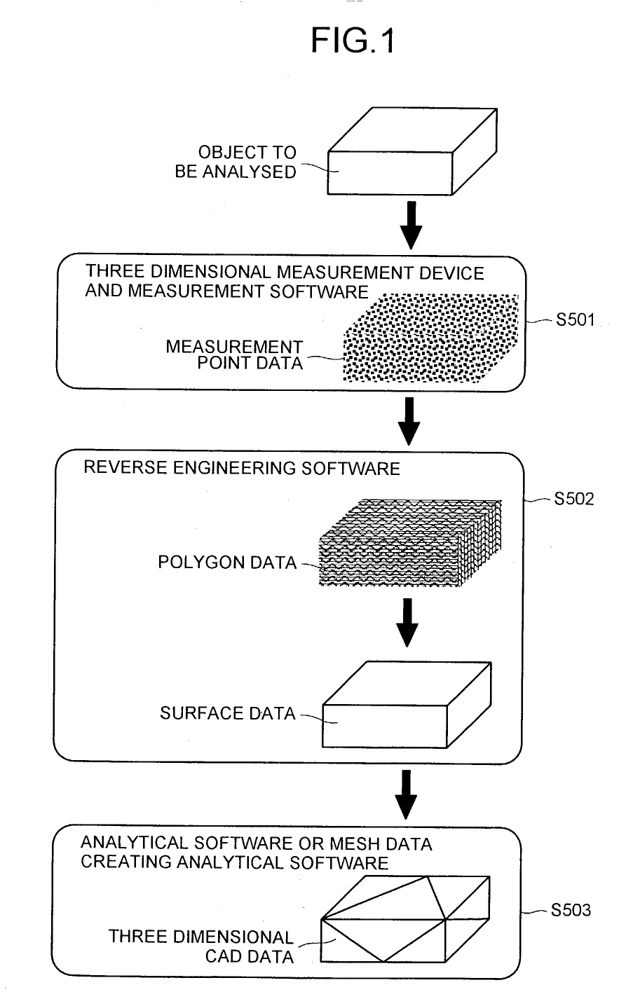

FIG. 1 is a diagram illustrating the process of creating analytical mesh data in the conventional art. As shown in FIG. 1, a three dimensional measurement device and measurement software analyses spatial data of an object to be analyzed (step S501). This process of analyzing the spatial data of the object is particularly required during the design phase when the three dimensional CAD data thereof do not exist. Then, a reverse engineering software program analyses the spatial data measured at step S501 and derives polygon data and then derives surface data from the polygon data (step S502). The polygon data is, for example, an accumulation of data about vertices of a plurality of triangles. The surface data is, for example, an accumulation of vertices of a plurality of rectangles. Finally, the mesh data creating analytical software program creates three dimensional CAD data using the surface data (step S503).

In this manner, conventionally, the reverse engineering software program is developed to interface with the mesh data creating analytical software. Furthermore, the surface data is required to obtain the final three dimensional CAD data.

However, long time and excess labor is required for defining the surface data at step S502. Moreover, the time required for creating the surface data is several times that of creating the polygon data.

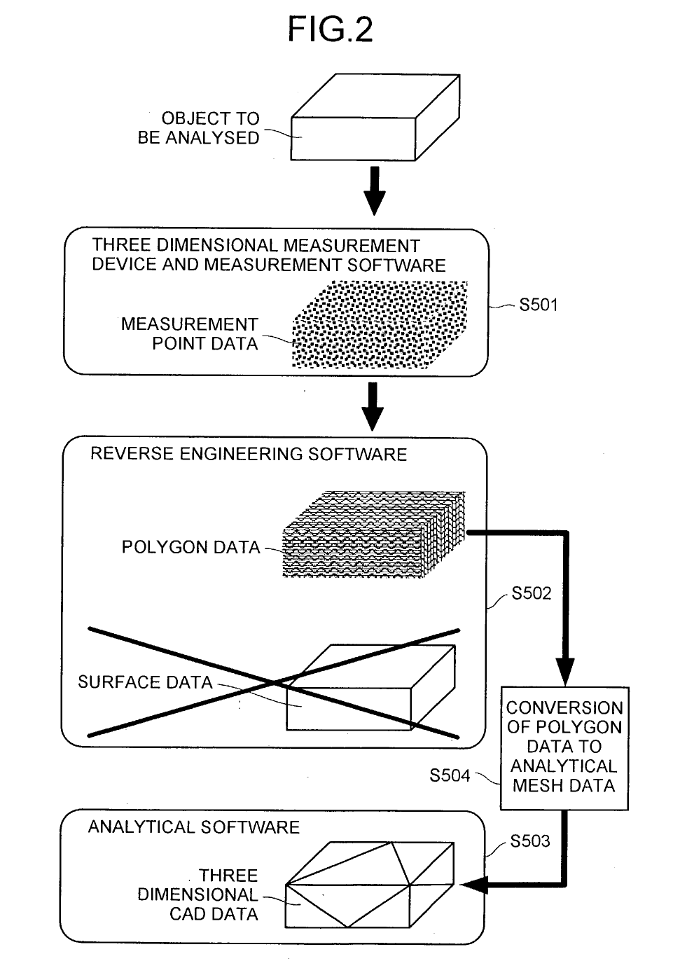

FIG. 2 is a diagram illustrating the process of creating the analytical mesh data according to an embodiment of the present invention. The polygon data is directly converted to the analytical mesh data. Same reference numerals in FIG. 2 have been used to represent the structural elements that have same structure or same function as those shown in FIG. 1.

According to the present invention, in the process of creating the analytical mesh data, the time consuming process of converting the polygon data to the surface data is not performed. Instead, the polygon data is directly converted to the analytical mesh data, thereby reducing the time required to create the analytical mesh data. The conventional process shown in FIG. 1 is a typical example of converting the measurement data of the object to the analytical mesh data thereof. The conventional process normally takes about ten days but the time can be reduced to two days if the process shown in FIG. 2 is employed.

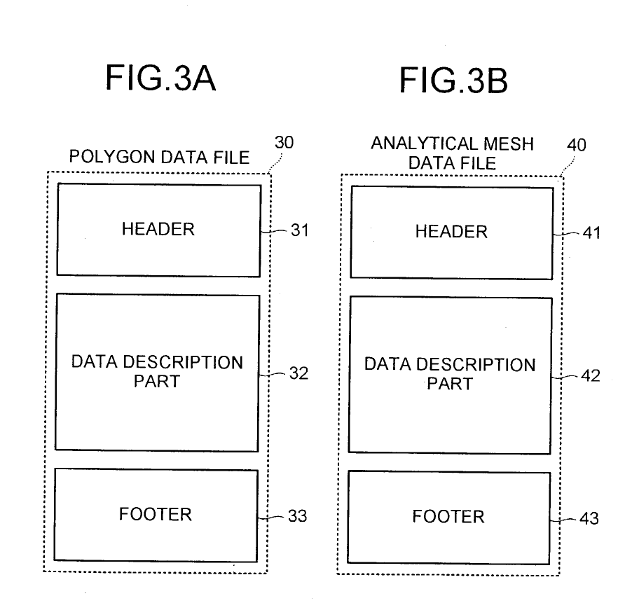

FIG. 3A is a diagram that shows the format of a file that contains the polygon data (hereinafter “polygon data file”) 30. FIG. 3B shows the format of a file that contains the analytical mesh data (hereinafter “analytical mesh data file”) 40. The polygon data file 30 consists of a header 31, a data description part 32, and a footer 33. The header 31 normally is a description of data type, creator, title and the like. The data description part 32 contains coordinates of vertices of an accumulation of triangles. The footer 33 indicates the termination of the polygon data file 30. In the same manner, the analytical mesh data file 40 consists of a header 41, a data description part 42, and a footer 43. The header 41 is a description of data type, creator, title and the like. The data description part 42 contains coordinates of an accumulation of triangles. The footer 43 indicates the end of the analytical mesh data file 40. However, instead of the footer, an end of file (EOF) code may also be included at the end of these data files.

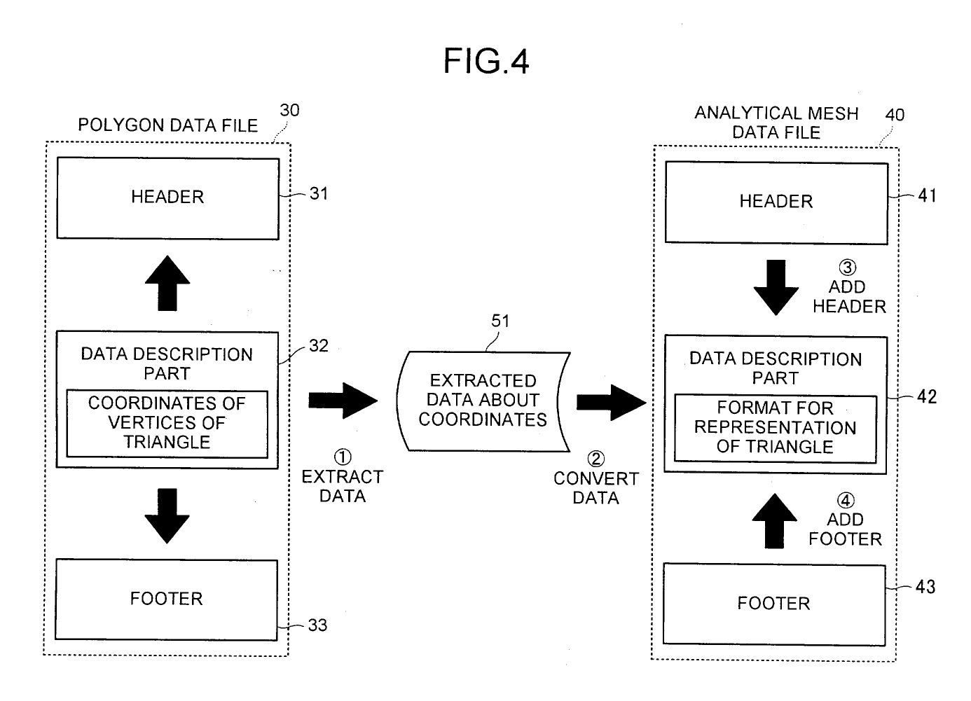

FIG. 4 shows how to create the analytical mesh data file 40 from the polygon data file 30. In FIG. 4, same reference numerals have been used to represent the structural elements that have same structure or same function as those shown in FIG. 3.

First, the coordinate values of vertices described in the data description part 32 of the polygon data file 30 are extracted (hereinafter referred as “extraction data 51”). Then, on the basis of the format stipulated by the analytical mesh data file 40, the extraction data 51 is converted to form the data description part 42. Following this, the header 41 and the footer 43 are added to the extraction data 51 based on the format of the analytical mesh data file 40.

The data description part of the polygon data file 30 and the analytical mesh data file 40 are basically a list of the x, y, z coordinates of vertices that form the triangular mesh data. Therefore, it is possible to obtain the analytical mesh data file 40 from the polygon data file 30 by simply changing the numbers, changing the arrangement of digits or the like.

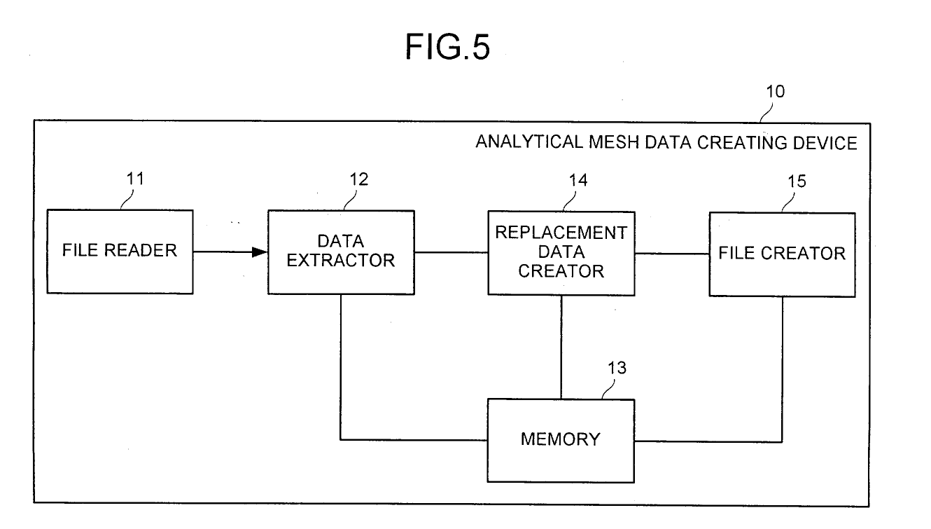

FIG. 5 is a block diagram that shows the functional configuration of the analytical mesh data creating device 10 of the embodiment of the present invention. The analytical mesh data creating device 10 comprises a data extractor 12, a file reader 11, a memory 13, a file creator 15, and a replacement data creator 14. This diagram explains the process of creating the analytical mesh data file. First, the data extractor 12 extracts the coordinate values of the vertices of multiple triangles (hereinafter “extracted data”) from the polygon data that is read by the file reader 11. Then, the extracted data is stored in the memory 13. Following this, the replacement data creator 14 reads the data stored in the memory 13, creates a replacement data based on the format that can be handled by the file creator 15, and stores the replacement data in the memory 13. Finally, the file creator 15 creates the analytical mesh data by adding a predetermined header and footer and stores the same in the memory 13.

The configuration of the analytical mesh data creating device 10 shown here implies that the data extractor 12, the replacement data creator 14, and the file creator 15 make use of memory 13 for transferring and receiving the data. Instead, the data extractor 12, the replacement data creator 14, and the file creator 15 may also internally store and directly transmit and receive data without using memory 13.

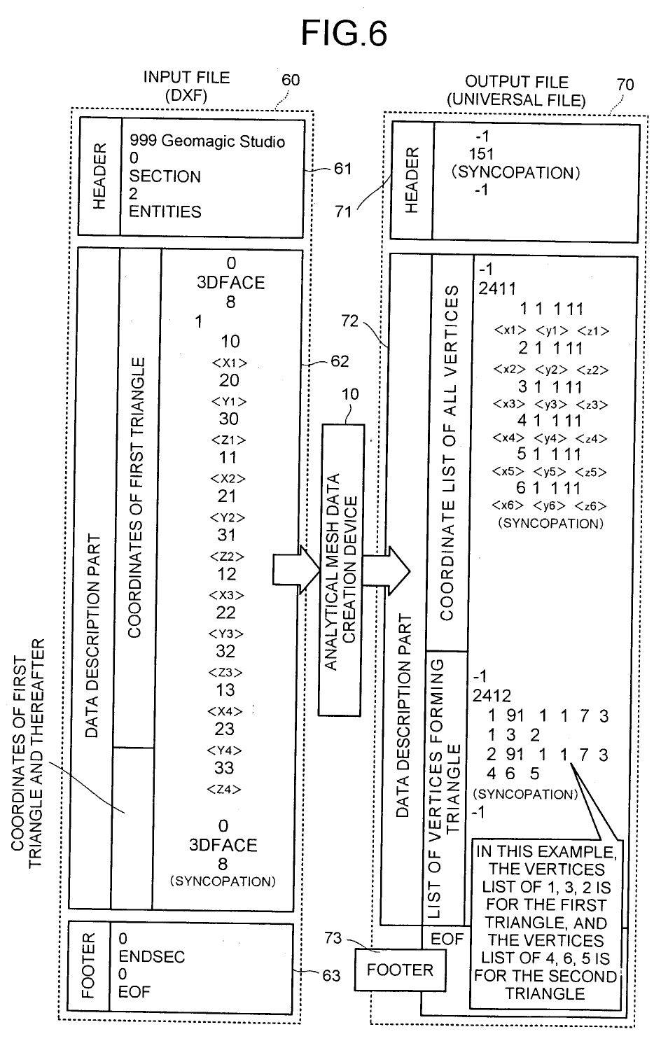

FIG. 6 shows the detailed format of an input data exchange format (DXF) file 60 and an output universal file 70. The DXF file 60 and the universal file 70 are respectively input into and output from the analytical mesh data creating device 10. The data format of the input file and the output file are compared and analyzed. The DXF file 60 consists of a header 61, a data description part 62, and a footer 63. The universal file 70 consists of a header 71, a data description part 72, and a footer 73. The basic data format of the input data exchange format file 60 and the output universal file 70 are similar to the data format of the polygon data file 30 and the analytical mesh data file 40 shown in FIG. 3.

The DXF file 60 has the de facto standard format of AutoCAD software, a proprietary of Autodesk Corporation and can contain two-dimensional and three-dimensional vector data. The universal file 70 has the file format of I-DEAS software, a proprietary of SDRC Corporation. The universal data file 70 can contain two dimensional and three dimensional analytical mesh data, and is supported by various analytical software.

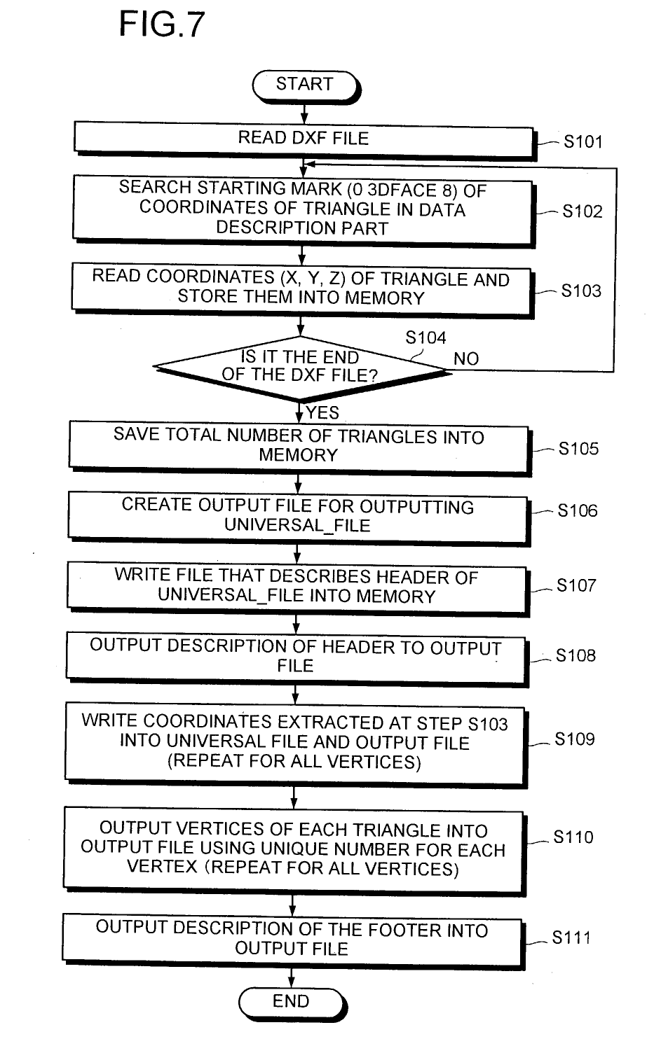

FIG. 7 is a flowchart that explains how a universal file 70 is created from the DXF file 60, and FIGS. 5 to 7 are for explaining this creation in detail.

First, the file reader 11 reads the DXF file 60 (step S101). Then, the data extractor 12 searches the data description part of the DXF file 60 for the part 0 3DFACE 8 that marks the start of the coordinates of the triangle (step S102). Then, the data extractor 12 reads the x, y, z coordinates of the triangle from the data description part and stores the coordinates in the memory 13 (step S103). The number 1 following the part 0 3DFACE 8 indicates that the coordinates following the number 1 belong to the first triangle (Refer to FIG. 6). For example, X1, Y1, and Z1 correspond to x, y, and z coordinates of a first point, X3, Y3, and Z3 correspond to the coordinates of a third point respectively. Normally, the DXF file 60 can also support rectangles. In case of the rectangles coordinates of four vertices are described. However, since the present example describes a triangle, the coordinates of a fourth point, that is X4, Y4, and Z4, are same as the coordinates of the third point.

Next, the data extractor 12 determines whether all the coordinates have been read (step S104). If at least one of the coordinates in the DXF file 60 has not been read (NO at step S104), then the process in steps S102 to 104 is repeated. On the other hand, if all the coordinates in the DXF file 60 have been read (YES at step S104), then the data extractor 12 stores the total number of the triangles in the memory 13 (step S105). Subsequently, the file creator 15 creates an output file for outputting the universal file 70 (step S106). The file reader 11 writes a file containing the predetermined header 71 (Refer to FIG. 6) into the memory 13 (step S107). Following this, the file creator 15 outputs the description of header 71 to the output file (step S108). Next, the replacement data creator 14 writes the coordinates extracted at step S103 in the data description part 72 of the universal file 70, and also outputs the coordinates to the output file (step S109). The process in step S109 is repeated for the vertices of each of the triangles.

Then, the replacement data creator 14 outputs into the output file the three vertices of each triangle according to the format of universal file 70 by using a unique number for each vertex of a triangle (step S110). The process in step S110 is repeated for the vertices of each of the triangles. Next the file creator 15 outputs the description of footer 73 that could also be EOF as shown in FIG. 6 to the output file (step S111). Finally, the entire process is terminated. In this manner, by performing the steps from S101 to S110, the polygon data in DXF format can be easily and speedily converted to the analytical mesh data in universal file format.

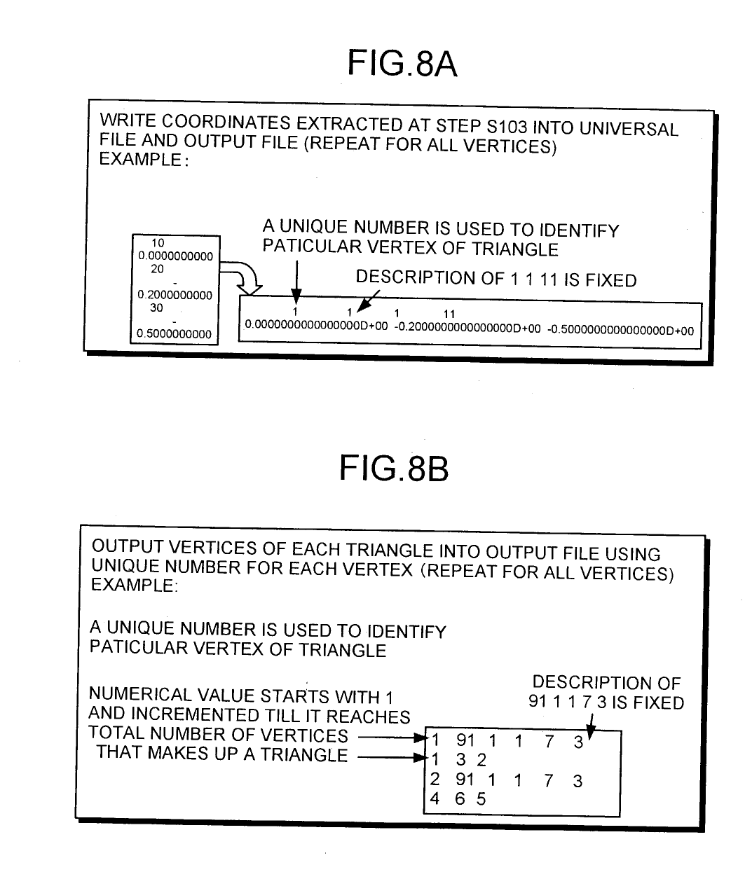

FIG. 8A is for explaining the step S109 and FIG. 8B is for explaining the step S110 in detail. In FIG. 8A, the coordinates of the triangle described in the data description part 62 of the DXF file 60 are replaced with the list of coordinates of vertices of the data description part 72. Here, only the first numerical value in the format 1 1 1 11 in the coordinates list of the data description part 72 is subject to change (Refer to FIGS. 6 and 8A). In this example, the first numerical value is 1 and is generally a unique number that is used to identify a particular vertex of a triangle. Normally, this unique numbering starts with 1 and is incremented for each vertex in each triangle. The numbers following this unique number, in this example 1 1 11, always remain constant and may be used to identify the coordinate system, the color of the nodal point of triangles, or the like.

FIG. 8B describes the list of vertices forming a triangle as shown in the data description part 72 of the universal file 70 (Refer to FIG. 6). In this list of vertices, only the first numerical value in the format 1 91 1 1 7 3 is subject to change. The first numerical value is again, a unique number attached to number all the vertices in all the triangles. It normally starts with 1 and is incremented for each vertex in each triangle. The numbers following the first numerical value, in this example 91 1 1 7 3, always remain constant and may be used to identify the number of the nodal point of the triangles. Further, the unique numbers present below the numbers 1 91 1 1 7 3, in this example, 1 3 2 and 4 6 5, are used to identify the vertices in the list of coordinates. For example, the unique numbers 1 3 2 indicate the coordinates of the vertices that form the first triangle. Further, the unique numbers 4 6 5 that are present below the numbers 2 91 1 1 7 3 indicate the coordinates of the vertices that form the second triangle. However, in the universal file 70, the front surface and the back surface of the triangle can be distinguished easily by the arrangement of the unique numbers. For example, the front surface is referred to as 1 3 2, and the back surface is referred to as 1 2 3.

The present invention achieves the effect of reducing the time required to convert the measurement data of the object to the analytical mesh data from a period of ten days to a short time frame ranging between two hours to two days.

A case of converting the polygon data in the DXF file format to the analytical mesh data in the universal file format has been explained above. However, this invention is not limited to these file formats. Any other file format may be used.

A program that executes a part or the entire functions performed by the analytical mesh data creating device 10 as shown in FIG. 5 may be realized in a computer system. In addition, the program may also execute a part or all of the processes shown in FIGS. 7 and 8. The computer system may include an operating system, peripherals or the like. Further, the computer system may also include the program installed beforehand.

As explained above, according to the present invention, the coordinates of vertices of triangles in the polygon data are extracted, the extracted coordinates are replaced with the coordinates of vertices in the analytical mesh data, and finally the header and the footer are attached to obtain the analytical mesh data. As a result, the present invention makes it possible to easily and speedily generate the analytical mesh data than in the conventional technology.

Further, the generation of the analytical mesh data can be carried out easily and automatically using a computer.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of creating analytical mesh data based on polygon data that is created based on measurement data of an object to be analyzed, comprising:
extracting coordinates of each vertex of each triangle in the polygon data;
replacing the extracted coordinates with corresponding coordinates of each vertex of each triangle of the analytical mesh data;
replacing a header of the polygon data with a header of the analytical mesh data; and
replacing a footer of the polygon data with a footer of the analytical mesh data.

2. The method according to claim 1, wherein the polygon data is a DXF file format and the analytical mesh data is in a universal file format.

3. A method of creating analytical mesh data based on polygon data that is created based on measurement data of an object to be analyzed, comprising:
extracting coordinates of each vertex of each triangle in the polygon data;
replacing the extracted coordinates with corresponding coordinates of each vertex of each triangle of the analytical mesh data; and
adding a predetermined header and footer to the analytical mesh data.

4. The method according to claim 3, wherein the polygon data is a DXF file format and the analytical mesh data is in a universal file format.

5. A device for creating analytical mesh data based on polygon data that is created based on measurement data of an object to be analyzed, comprising:
a data extractor that extracts coordinates of each vertex of each triangle in the polygon data;
a data replacer that replaces the extracted coordinates with corresponding coordinates of each vertex of each triangle of the analytical mesh data; and
a file creator that adds a predetermined header and footer.
